(19) United States
(12) Patent Application Publication
(10) Pub. No.: US 2014/0272850 A1
(43) Pub. Date: Sep. 18, 2014

(54) METHOD FOR RELIEVING PAIN AND A KIT THEREFOR

(71) Applicant: GET YOUR BACK ON TRACK LLC, Cincinnati, OH (US)

(72) Inventor: Mary Beth Knight, Cincinnati, OH (US)

(73) Assignee: Get Your Back On Track LLC, Cincinnati, OH (US)

(21) Appl. No.: 13/827,431

(22) Filed: Mar. 14, 2013

(51) Int. Cl. G09B 19/00

(52) U.S. Cl. CPC G09B 19/00
USPC 434/247

(57) ABSTRACT

A kit for use in physical therapy by a person includes a tension release device and a set of instructions associated with the kit. The set of instructions is in the form of written instructions and/or audio/visual instructions. The set of instructions includes an instruction to place pressure on a muscle of a person with the device, an instruction to stretch the muscle, and an instruction to strengthen at least one core muscle. The instruction to place pressure may be provided before the instruction to stretch, and the instruction to stretch may be provided before the instruction to strengthen. The kit may include other tension release devices. A method of physical therapy for use by a person includes providing a tension release device to apply pressure to a muscle of the person and providing a set of instructions to perform.

### FIELD OF THE INVENTION

The present invention relates generally to a method for use by a person to relieve pain, manage pain, and improve soft tissue function, joint function, and physical performance, and, more particularly, to a method of physical therapy for pain relief and a kit for use with the method.

### BACKGROUND OF THE INVENTION

Chronic pain is a problem for a significant number of people. For example, more than 75% of Americans will suffer from back pain at some point in their lives. There are literally millions of Americans suffering from numbness, loss of range of motion, tingling and pain in their torso, including in their lower back and in their neck, and in their extremities including their legs and their arms. These pain sufferers know that chronic pain can be frustrating, debilitating, and aggravating.

There are numerous sources of pain. Pain in the back and legs can be due to misalignment of the spine and other joints. In this case, the pain may be caused by or result in poor posture. Ultimately, the pain can cause chronic muscle contraction or muscle spasms. Weakness of and low flexibility of muscles in these areas and other areas can also cause pain. Most cases of back pain are mechanical, meaning that they are not caused by arthritis, fractures, or cancer. Environmental factors that cause stress may aggravate existing pain or cause pain and can lead to involuntary contraction of muscles and misalignment of joints and thus produce pain.

Treatment for pain and loss of proper joint function often does not adequately or proactively address all sources of pain or loss of function (also known as range of motion) and/or does not provide the pain sufferer with a long-term plan for improving and maintaining physical health and preventing pain. For example, physical therapy (or physiotherapy) services are often utilized to address pain in the back and legs. In many settings, these services may be provided alongside, or in conjunction with, other medical or rehabilitation services. Physical therapy tends to be symptom-based and generally offers only temporary relief from pain of the injured area, but does not always treat other issues in the body that could cause additional pain or a reoccurrence of the injury. Thus, physical therapy does not typically offer long-term, proactive instruction in the exercise protocols, posture models, breathing methods, and stress management techniques that can provide long-term relief from pain. Most physical therapy patients are sent home with a list of exercises to perform on their own, without verbal instruction, making it difficult for the patient to properly participate in the rehabilitation program. Physical therapy can also be limited by its scope due to limited insurance reimbursement and the expense of long-term care.

People who suffer from pain, particularly back and/or leg pain, may seek out chiropractic therapy. It is known that chiropractic therapy has the capability to realign joints and thus addresses pain that may be associated with improper alignment of joints. Even so, as is the case with physical therapy, patients are typically not taught proper posture, proper breathing techniques, or proper exercise habits which create the muscle memory necessary for the body to hold the correct position long term. Without a long-term, proactive approach, clients of both physical therapy and chiropractic therapy tend to return to the habits, movement patterns, and posture that caused their problems in the first instance.

Other treatments may include analgesic and muscle relaxant drug therapies. However, these treatments often focus on treating the pain and not the source of the pain. As such, they provide only temporary relief from pain.

Thus, what is sought is an improvement in treatment over traditional pain relief, joint function and prevention treatments by addressing the causes of pain or malfunction and by providing the pain sufferer with the self-treatment methodology needed to carry out a long-term program for improving health, managing existing pain, and preventing future pain, and which overcomes one or more of the shortcomings and problems set forth above.

### SUMMARY OF THE INVENTION

The present invention overcomes the foregoing and other shortcomings and drawbacks of treatment methodologies heretofore known for use in treating physical pain in the back/or in the legs. While the present invention will be described in connection with certain embodiments, it will be understood that the present invention is not limited to these embodiments. On the contrary, the present invention includes all alternatives, modifications and equivalents as may be included within the spirit and scope of the present invention.

In accordance with the principles of the present invention, a kit for use in physical therapy by a person comprises a first tension release device configured to apply pressure to at least one muscle of the person. A set of instructions is associated with the kit and is in the form of written instructions and/or audio/visual instructions for the person to perform. The set of instructions comprises a first instruction to place pressure on at least one muscle of the person with the first tension release device, a first instruction to stretch the at least one muscle of the person, and a first instruction to strengthen at least one core muscle of the person.

According to one aspect of the present invention, the first instruction to place pressure on the at least one muscle is provided before the first instruction to stretch the at least one muscle, and the first instruction to stretch the at least one muscle is provided before the first instruction to strengthen the at least one core muscle.

According to one aspect of the present invention, the kit further comprises a second tension release device that is different from the first tension release device. The second tension release device is configured to apply pressure to the at least one muscle of the person or another muscle of the person. The first instruction to place pressure on the at least one muscle of the person includes an instruction to place a second pressure on the at least one muscle or another muscle of the person with the second tension release device.

According to one aspect of the present invention, the kit further comprises a second tension release device configured to apply a pressure that is greater than the pressure capable of being applied by the first tension release device. And, a second set of instructions is associated with the kit and is in the form of written instructions and/or audio/visual instructions for the person to perform after the person performs the first set of instructions. The second set of instructions comprises a second instruction to place a second pressure on at least one second muscle of the person with the second tension release device, a second instruction to stretch the at least one second muscle of the person, and a second instruction to strengthen at least one core muscle of the person.

According to one aspect of the present invention, the kit further comprises a third tension release device configured to apply a pressure that is greater than the pressure capable of being applied by the second tension release device. And, a third set of instructions is associated with the kit and is in the form of written instructions and/or audio/visual instructions for the person to perform after the person performs the second set of instructions. The third set of instructions comprises a third instruction to place a third pressure on at least one third muscle of the person with the third tension release device, a third instruction to stretch the at least one third muscle of the person, and a third instruction to strengthen at least one core muscle of the person.

In accordance with the principles of the present invention, a method of physical therapy for use by a person comprises providing a first tension release device configured to apply pressure to at least one muscle of the person and providing a set of instructions to the person for the person to perform. The set of instructions comprises an instruction to place pressure on the at least one muscle of the person with the first tension release device, an instruction to stretch the at least one muscle, and an instruction to strengthen at least one core muscle.

According to one aspect of the present invention, the instruction to place pressure on the at least one muscle of the first person is before the instruction to stretch the at least one muscle, and the instruction to stretch the at least one muscle is before the instruction to strengthen the at least one core muscle.

According to one aspect of the present invention, the method further comprises providing a second tension release device configured to apply pressure to at least one second muscle of the person and providing a second set of instructions to the person for the person to perform after the person performs the first set of instructions. The second set of instructions comprise an instruction to place a second pressure on the at least one second muscle of the person with the second tension release device, an instruction to stretch the at least one second muscle, and an instruction to strengthen at least one core muscle.

According to one aspect of the present invention, the method further comprises providing a third tension release device configured to apply pressure to at least one third muscle of the person, and providing a third set of instructions to the person for the person to perform after the person performs the second set of instructions. The third set of instructions comprise an instruction to place a third pressure on the at least one third muscle of the person with the third tension release device, an instruction to stretch the at least one third muscle, and an instruction to strengthen at least one core muscle.

The above and other objectives and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the present invention given above and the detailed description of the embodiments given below, serve to explain the principles of the invention.

FIG. 1 illustrates a kit according to one embodiment of the present invention;

FIG. 2 illustrates exemplary tension releasing devices, a strap, and a set of instructions in one embodiment of the present invention;

FIG. 2A depicts an exemplary insert including a QR code, a bar code, and/or a URL associated with one of the tension releasing devices shown in FIG. 2;

FIGS. 3-8 are pictures illustrating release exercises utilizing components of the kit shown in FIG. 2 according to embodiments of the present invention;

FIGS. 9-16 are pictures illustrating stretching exercises according to embodiments of the invention;

FIGS. 17-26 are pictures illustrating strengthening exercises according to embodiments of the present invention;

FIGS. 27-32 are pictures illustrating additional or alternative release exercises from those illustrated in FIGS. 3-8 utilizing components of the kit shown in FIG. 2 according to embodiments of the present invention;

FIGS. 33-37 are pictures illustrating additional or alternative stretching exercises from those illustrated in FIGS. 9-16 according to embodiments of the present invention;

FIGS. 38-41 are pictures illustrating additional or alternative strengthening exercises from those illustrated in FIGS. 17-26 according to embodiments of the present invention;

FIGS. 42-51 are pictures illustrating additional or alternative release exercises from those illustrated in FIGS. 3-8 and 27-32 utilizing components of the kit shown in FIG. 2 according to embodiments of the present invention;

FIGS. 52-56 are pictures illustrating additional or alternative stretching exercises from those illustrated in FIGS. 9-16 and 33-37 according to embodiments of the present invention; and

FIGS. 57-63 are pictures illustrating additional or alternative strengthening exercises from those illustrated in FIGS. 17-26 and 38-41 according to embodiments of the present invention.

### DETAILED DESCRIPTION OF THE INVENTION

Referring now to the drawings, and to FIGS. 1 and 2 in particular, in one embodiment of the present invention, a kit 10 includes a plurality of tools 11 and a set of instructions 20 associated with the kit 10. The kit 10 may be used by a person generally anytime and anywhere, that is, the person may self-treat their pain or loss of function by using the kit 10 at the person's convenience. When a person uses the tool and performs exercises, as are described by the instructions, the person may experience a reduction in pain and an improvement in their quality of life. To that end, embodiments of the present invention are intended to be used by an individual where the individual may utilize any single one or all of the tools of the kit while following the instructions associated with the kit 10.

In general, according to embodiments of the present invention, and as described in detail below, the instructions describe a method for physical therapy that includes three different modalities or three different types of exercises. In one modality, the instructions direct the person to place pressure on one or more muscles to release tension generally, and to release trigger points specifically, in those muscles. In a second modality, the instructions direct the individual to stretch one or more muscles to lengthen the muscle to its proper length. In a third modality, the instructions direct the person to strengthen one or more core muscles to increase the endurance and load carrying capability of the muscles. In one embodiment, this regimen can be generally categorized as comprising the three exercise steps or stages of releasing tension or pressure points, stretching, and strengthening the core muscles. Advantageously, an individual who has pain and who follows the instructions through an exercise including all three modalities may experience a significant decrease in pain or a complete relief from pain and/or loss of function. And, continued use of the kit 10 described herein may provide long-term relief from pain and/or loss of function.

With reference to FIGS. 1 and 2, in one embodiment, the kit 10 may include one or more of a plurality of tension release devices 12 and the set of instructions 20 that describe utilizing one or more of the tension release devices 12 to release tension or pressure points. By way of example only and not limitation, the tension release devices 12 may include a cylindrical roller 14, a larger ball 16, and a smaller, textured ball 18. The kit 10 may also include other tools 11. For example, the kit 10 may also include a strap 22 for use during the stretching modality. In the representative embodiment shown, the plurality of tension release devices 12, the strap 22, and the set of instructions 20 may be contained in a container 24, such as, a bag or sack.

With reference to FIG. 2, in one embodiment, the roller 14 has a generally tubular configuration and may have surface textures and may include hardness variation along its outer surface. The outer surface may be made of a foam material. That is, the roller 14 may compress more in some areas than in other areas when subject to the same loading. Exemplary rollers 14 suitable for use in embodiments of the present invention include The Grid™ available from Trigger Point Technologies, LLC, Austin, Tex.

In one embodiment, the larger ball 16 may have a diameter between about 4 and about 7 inches, for example, and may be made of a foam material or other compressible material that is capable of elastically deforming when subject to a portion of a person's body weight being applied to the ball 16. Exemplary balls that are suitable for use in embodiments of the present invention include those commercially available from Power Systems of Knoxville, Tenn., such as a Myo-therapy ball. The smaller, textured ball 18 is smaller than the larger ball 16 and may have a diameter between about 2 inches and about 4 inches, for example. The smaller ball 18 may have a textured external surface, for example, a spiky surface, and is also elastically compressible when subject to a portion of a person's body weight being applied to the ball 18. Such balls are also commercially available from FitBall®, such as the FitBall® Body Therapy ball. The strap 22 may have a length from about 4 feet to about 6 feet and may have a loop or other construction at one end thereof by which the strap 22 may be made into or include an adjustable loop to cinch a foot or another body part. The strap 22 may be referred to as a “yoga strap” herein. As described above, one or more of the tools 14, 16, 18, and 22 may be utilized during practice of the method of physical therapy described in the set of instructions 20, as described below.

In the representative embodiment, the set of instructions 20 is illustrated and described herein in the form of a DVD. It will be appreciated, however, that the media, e.g., a DVD, in which the instructions are provided, is not particularly limited to a DVD, as other media forms may be utilized, including printed material, such as posters and/or instruction pamphlets, and other suitable forms of audio/video media for an individual to follow.

By way of example only, and with reference to FIG. 2A, the kit 10 may include an insert 26 having a machine readable code provided thereon, such as, for example, a QR code 28, a bar code 30, and/or a reference to a URL 32 that identifies a user-accessible website. By way of further example, the QR code 28, bar code 30, and/or URL 32 may be provided on packaging for one or more of the tools 11 and/or on the container 24, and/or on packaging for the container 24. The QR code 28 and/or bar code 30 may be read by any conventional QR code or bar code reader known to those of ordinary skill in the art. Once the QR code 28 and/or bar code 30 is read, the user is directed to a predetermined website which provides the set of instructions 20 which may be viewed online or printed.

In addition, or alternatively, the kit 10 may include a reference to the URL code 32, which can be accessed by a person via the Internet so the instructions 20 may be viewed on the website or printed. In one embodiment, a person may be provided with the URL code 32 when one of the tools 11 is purchased. The URL code 32 then provides access to the necessary files for downloading the instructions 20 for using the kit 10 after completion of an online purchase of the kit 10.

As set forth above, the set of instructions 20 describes a method for physical therapy, particularly soft tissue therapy, that an individual may perform by themselves. According to one embodiment, an individual may perform at least one exercise in each of the three modalities (i.e., release, stretch, and strengthen) as are described in the set of instructions 20. As described above, the modalities include selected exercises that are each configured to address or affect the physiological state of a muscle. For the release modality, the exercises are configured to massage the soft tissues of the individual's body which is referred to herein as “releasing.” Releasing may include utilizing one or more of the tension release devices 12 to apply pressure to the particular muscle, tendon, or fascia. As described herein, applying pressure or releasing may include rolling the muscle with one of the tension release devices 12 by which the individual self-massages a selected muscle or group of muscles. Releasing may therefore include reducing tension in the muscle and causing the muscle to relax, and releasing may focus on releasing trigger points, which are clusters of muscle fiber that are tense and short. Releasing may also include massaging the golgi tendon organ to help relax the muscle.

In the stretch modality, exercises include putting a selected muscle in tension to lengthen the muscle. And, yet a third type of modality includes strengthening exercises by which the load carrying capacity of the muscle and endurance are increased, and the muscle is taken through its full range of motion.

The exercises from each of the release modality, stretch modality, and strengthen modality may generally be performed in any order, but it is preferable that each modality be performed. Nevertheless, it has been discovered that the particular order in which the individual performs one or more of the releasing, stretching, and/or strengthening modality exercises may positively affect the overall reduction of, or improvement in, pain in the individual's muscles when performed in the order of release, stretch, and strengthen as described in detail below.

In one embodiment of the present invention, the set of instructions 20 directs the individual to first perform at least one release modality exercise on at least one muscle and then perform at least one stretch modality exercise on the muscle which was the target of the release modality exercise. Following releasing, the muscle is more susceptible to proper extension upon stretching. Thus, stretching after releasing is more likely to lengthen the muscle to its proper length. Lastly the instructions direct the individual to perform at least one strengthening modality exercise on a core muscle, which may be the antagonist for the muscle that was first released and then stretched. The muscles subject to strengthening may include one or more of the core muscles.

Furthermore, in one embodiment, the set of instructions 20 may direct an individual to perform multiple exercises for each modality, i.e., release, stretch, and strengthen. In addition, the set of instructions 20 may include multiple stages or levels of increasingly more intense exercises for each modality. For example, in the initial level, i.e., level 1, releasing, stretching, and strengthening exercises may be for an individual who is inexperienced with these types of exercises. Once the level 1 exercises are mastered, the individual may proceed to the next level, i.e., level 2, in which the exercises for each modality are designed to be more intense than those in level 1 to further improve and condition the individual's body and reduce or manage any pain that may have persisted following level 1. Once the level 2 exercises are mastered, the individual may proceed to the next level, i.e., level 3, in which the exercises for each modality are designed to be more intense than the exercises of level 2 to further improve and condition the individual's body and reduce or manage any pain that may have persisted following level 2. While representative exercises are illustrated and described herein with respect to a particular side, such as the left leg or right leg, it will be appreciated that the exercise is also generally applicable to the other side of the body, although that separate exercise is not shown in the figures.

Embodiments of the method of physical therapy described herein may be used by an individual to self-treat a variety of muscles, tendons, and fascia within their body. These muscles may include any muscle that is accessible to application of pressure by the individual during releasing. In particular, these muscles may include those found in the head, neck, shoulder, arm, hand, mid back, low back, hips, glutes, thighs, knees, calves, heels, and feet. Thus, the embodiments of the method of physical therapy described herein may be used by an individual to address pain in these areas.

Pain related to a particular region of the human body, and by way of example only, may include migraines, headaches, tension headaches, loss of mobility, problems with forward posture, arthritis, spinal stenosis, pinched nerves, Frozen Shoulder Syndrome, pain when reaching the hands over the shoulder, loss in the range of motion, tennis elbow, Carpal Tunnel Syndrome, wrist pain and/or loss of range of motion in the wrist, poor posture, muscle strain, compressed vertebrae, degenerative disc disease, sciatica, IT Band Syndrome, Piriformis Syndrome, tight hips, loss or range of motion in the hips, tight hamstrings, patella femoral tendinitis, Chondromalacia, Plantar fasciitis, loss of range of motion in the ankle and/or toes, poor circulation, fluid accumulation, and/or general tension and/or stiffness.

Specific muscles may include those identified in the regions described above. In particular, muscles in the back and legs may include the muscles of the hip, including the gluteal muscles, which generally make up the buttocks. These, specifically include the gluteus maximus, gluteus medius, and gluteus minimus muscle. The muscles of the hip also include adductor muscles, which include the tensor fasciae latae muscle, adductor brevis, adductor longus, adductor magnus, pectineus, gracilis, and sartorius. Muscles of the hip may also include the muscles in the iliopsoas group, including the iliacus and psoas major, and the lateral rotator group muscles, including the externus and internus obturators, the piriformis, the superior and inferior gemelli, and the quadrates femoris. Muscles in the back may include the quadratus lumborum or “QL,” the erector spinae, and the latissimus dorsi, among others.

The core muscles may generally include muscles that attach to the spine, hip, and/or shoulder. These include the abdominal muscle group or “abs.” Generally the abdominal muscle group includes the rectus abdominus, the transverse abdominus, and the internal and external obliques. The core muscles may also include muscles of the hips, as set out above, and muscles of the back, such as the erector spinae, quadratus lumborum, paraspinals, and the psoas major.

With reference now to FIGS. 1 and 3, in a representative embodiment of the present invention, the set of instructions 20 may be provided on a DVD that presents an instructor who may direct the individual through each of the release, stretch, and strengthen exercises for an initial level of intensity (i.e., level 1) and who may demonstrate the various exercises as are illustrated in the figures and described herein.

In particular, the instructor may direct the individual to perform release modality exercises. In this regard, the instructor may direct the individual to move their body across one of the tension release devices 12 to apply the individual's body weight or portion of the individual's body weight to the device 12 and may be referred to as “rolling” or “self-massage.” In this regard, the instructor may direct the individual to position himself or herself on a mat so that the tension releasing device 12, in the representative form of the roller 14, is located on the front of the right hip, as shown. By rolling forward across the roller 14, pressure is applied to the quadriceps or the thigh muscle until the roller 14 reaches the upper part of the hip. This motion may be repeated in the reverse direction. Further back-and-forth rolling motion may apply pressure via the roller 14 on the muscle between the hip and the quadriceps, as is indicated by the arrow in FIG. 3. The instructor may direct the individual to inhale and exhale during the forward and backward rolling motion. In one embodiment, to apply more pressure, the instructor may direct the individual to allow more of the individual's body weight to rest on the roller 14. It will be appreciated that the applied pressure massages out tightness, or as referred to herein “trigger points,” “knots,” or “hotspots,” in the muscle, which may be thought of as a cluster of nerves that cause tension in the muscle so that the muscle is sensitive to applied pressure.

With continued reference to FIG. 3, the instructor may describe locating an area of the muscle that is more tense or sensitive to the applied pressure, which may have more pain or discomfort, than in another area of the muscle. This may be referred to as a trigger point in that area. To do so, the individual may be instructed to roll forward and backward, per the arrow in FIG. 3, until the roller 14 resides on the trigger point. Once the trigger point is located, the individual may be instructed to take a few deep breaths and then apply stationary pressure with the roller 14 to the trigger point for a fixed amount of time, generally for a five count or so. Direct application of pressure to the trigger point may be discontinued if the individual's discomfort level goes above a 6 on a scale from 1 to 10.

Although not shown in FIG. 3, the instructor may direct the individual to repeat the above rolling procedure to place pressure on the left hip flexor. During application of pressure to the left hip flexor, the instructor may prompt the individual to consider whether there is a difference between the left hip flexor and the right hip flexor of their body. This may prompt the individual to be more aware of the health of their body. Again, similar to the right hip flexor, the instructor may direct the individual to find the trigger point on that front hip that feels a little more uncomfortable and then rest on the roller 14 on that location to apply pressure to that trigger point for a few moments to facilitate release of the tension in the muscle.

With reference to FIG. 4, in one embodiment, releasing modality exercises may include application of pressure to the outside muscles of the hip. As shown in FIG. 4, the roller 14 may be used to apply pressure to the right hip to treat the muscles that help move the leg away from the body. The individual may support themselves with their forearm or hand, as shown, to take some of the pressure off of their hip, if need be. Both feet may be positioned on the floor. The individual may roll the roller 14 in one direction to bring the roller 14 closer to the top of the hip and then roll themselves in the reverse direction to bring the roller 14 to a lower position on the hip to release tension in this muscle. This rolling or pressure application process may be repeated. The instructor may direct the individual to inhale and exhale during rolling. It will be appreciated that to apply more pressure with the roller, the individual may be directed to lift their feet off of the floor.

In one embodiment, rolling in this location of the hip may include identifying a trigger point and then applying a static or stationary pressure to that location for a five count. The instructor may direct the individual to utilize the same procedure on the left hip, while again prompting the individual to notice any difference between the left and right side of the body. And again, the instructor may direct the individual to try to find a trigger point or location of discomfort and apply pressure to that location for a five count.

With reference now to FIG. 5, in one embodiment, the set of instructions may direct the individual to a seated position with the roller 14 under one of the gluteus muscles. Thus, placing pressure may include rolling the roller 14 on the gluteus muscles as is indicated generally by the arrow in FIG. 4. In the position shown, the individual may rotate their legs, so that they are somewhat off to the side of the gluteus. In this location, the roller 14 may be positioned to apply pressure or roll across the gluteus medius, which is up near the top of the hip bone on the back side of the human body. It will be appreciated that individuals who sit for long periods of time may feel some tightening and significant trigger points or tightness in the gluteus muscles. The individual may be directed to roll back and forth on the roller 14 multiple times.

Once completed, the individual may be instructed to identify the trigger point or “hotspot” and apply direct pressure via the roller 14 to that location while breathing deeply. The instructor may direct the individual to apply the same rolling pressure application process to the other side of the buttocks. Specifically, the individual may be directed to place the roller 14 off the middle of the glutes and to one side. The individual may then roll across the roller 14 toward the hip bone in the back and then roll down to the middle of the glutes and then back again along a reverse course. Once complete, the individual may be directed to find the trigger point for that side and then to place direct pressure on the trigger point with the roller 14 to relax the muscles.

With reference now to FIG. 6, in one embodiment, releasing may include placing the roller 14 in a position to apply pressure to the muscles that run on either side of the spine in the lower back region. To do so, the individual may sit down on the mat and position the roller 14 above their hips but below the individual's rib cage. The instructor may direct the individual to place one hand behind their head to assist their neck if they have any discomfort in their neck. By leaning back onto the roller 14, the individual can put some of the pressure on their arms. Accordingly, all of their weight may not be on the roller 14. The individual may be directed to roll their hips down the mat in the direction indicated by the arrow in FIG. 6. This motion will allow the roller 14 to roll towards their shoulder blades. Once at the shoulder blades, the individual may roll the roller 14 toward their hips. To do so, the individual may push with their feet or use their hands for assistance to bring their hips closer to the roller 14 to massage the lower back. It will be appreciated that this motion massages out the erector muscles. Once again, the instructor may direct the individual to identify a hotspot or a trigger point and then apply direct stationary pressure to that hotspot.

With reference now to FIG. 7, in one embodiment, releasing may include placing the ball 16 underneath the right gluteus. The instructor may direct the individual to roll on the ball 16. Thus, the individual may apply pressure by rolling on the ball 16 from the tailbone out towards the hip in a gentle, slow back-and-forth motion in the direction indicated by the arrow in FIG. 7. In particular, this motion may apply pressure to the piriformis muscle. It will be appreciated that the piriformis muscle may cause pain for those people who sit for long periods of time. Once rolling on the ball 16 is performed, the instructor may direct the individual to identify a trigger point or a hotspot and then hold the ball 16 on that location. Also, in one embodiment, the instructor may direct the individual to rotate their corresponding foot to the side and let the piriformis muscle relax. In one embodiment, the instructor directs the individual to switch sides and roll on the ball 16 from the hip toward the tailbone, but not all the way onto that bone, in a side-to-side motion, to focus on the piriformis muscle on the other side. Again, the instructor may direct the individual to identify a trigger point for a hotspot and then apply stationary direct pressure to that location.

With reference now to FIG. 8, in one embodiment, releasing may include placing the roller 14 on a chair (as shown) and applying pressure to the inner thigh muscles. In this regard, the instructor may direct the individual to place the roller 14 in the middle of the chair with one foot on either side of the chair to rest the individual's inner thigh on the roller 14. It will be appreciated that the individual can use the back of the chair and/or the seat of the chair to take pressure off of the roller 14 and to help move the individual's inner thigh back and forth across the roller 14. Movement may include rolling from close to the knee to close to the hip and back again along the inner thigh muscle.

In one embodiment, the instructor may direct the individual to find a hotspot or trigger point. In this regard, the instructor may direct the individual to turn their toes up or to point them down toward the floor in an effort to find an area of the inner thigh that feels tight. Once located, the individual may place stationary, rather than moving, pressure on the trigger point. Once rolling of the right inside thigh muscle is complete, the instructor may direct the individual to switch to the other inner thigh. The instructor may direct the individual to perform the same type of motion on the roller 14 while turning their toes towards the floor so that they work the inner thigh muscles. It will be appreciated that moving the roller 14 along the inner thigh in a back-and-forth motion may massage the adductor muscles. Again, the instructor may direct the individual to identify a hotspot or trigger point and that it may be necessary to rotate the knee in or out to locate the hotspot or trigger point. Once identified, pressure against the roller 14 on the identified hotspot may release at least some of the tension at this location.

In one embodiment, the set of instructions directs the individual through a specific sequence of release exercises with the roller 14 and the ball 16. In particular, in one embodiment, the set of instructions directs the individual through the sequence illustrated consecutively by FIGS. 3, 4, 5, 6, 7, and then 8. However, it will be appreciated that rolling selected muscles with the roller 14 may be completed in any order and embodiments of the present invention are not limited to a specific order for placing pressure on, e.g., rolling, muscles in the hips, legs, and back. In one embodiment, following application of pressure with one or more of the tension release devices 12 identified above, the instructor may direct the individual to stretch one or more of those muscles, as described below.

With reference to FIG. 9, in one embodiment, the instructor may direct the individual to perform one or more stretch modality exercises to stretch one or more muscles. It is believed that the timing of the stretching of the one or more muscles after releasing may be advantageous to the individual. In particular, it is believed that stretching immediately following releasing or rolling, as described above, may be the most beneficial. While not being bound by theory, it is thought that once the tension in the muscle is released, the muscles are in a condition in which stretching provides the most benefit. However, it is contemplated that stretching a few hours, for example, up to about 6 to about 8 hours, after releasing may also produce some benefits. In this regard, in one embodiment, releasing may be performed in the morning, stretching may be performed at lunch time, and strengthening, as set out in detail below, may be performed in the evening. It will be appreciated that the benefits associated with the method as described herein is dependent upon the individual, particularly their age and their general health prior to performing the exercises as described herein.

Referring now to FIG. 9, in one embodiment, stretching includes stretching the muscles of the hip. To do so, the individual may place their right foot out to one side of the chair with their left foot on the opposing side of the chair, as shown. The individual may use the back of the chair and/or the seat of the chair for support. In this position, the individual may already feel a stretch in the front of their left hip. The instructor may direct the individual to remain in this position if some stretch is felt in the front left hip muscle. If the individual does not feel the stretch yet, the instructor may direct the individual to bend their front knee and lower their thigh towards the seat. In addition, the instructor may direct the individual to draw their shoulders back and down and hold in this position to enhance the stretch of the left hip muscle, as is indicated by the arrows in FIG. 9. This position may be held for a few seconds, generally less than 30 seconds, typically about 20 seconds, while the individual takes deep breaths.

After a set period of time, the instructor may direct the individual to repeat the stretch for the right hip. Though not shown, the individual may reverse their position so that their left foot is in front of them with their foot on the floor and the right foot is positioned on the opposing side of the chair on the floor. This position may be achieved by simply turning their body to face the other direction. Again, the individual may use the back of the chair and the seat for support. The instructor may direct the individual to point their toes in the same direction and to the lift up and straighten out their back leg and bend their front leg so they feel the stretch in the front of the right hip. The instructor may direct the individual to breathe deeply and to keep their shoulders back and down while stretching their right hip. Again, the stretch may be held for generally less than 30 seconds, typically about 20 seconds. The instructor may direct the individual to try not to bounce while staying in one place to let those muscles lengthen.

With reference now to FIG. 10, in one embodiment, the instructor may direct the individual to assume a seated position in the chair, as shown. In a position near the front of the seat, the individual may extend their right leg away from their body and roll their toes (on their right leg) towards the floor. By keeping their leg straight, the individual may feel a stretch in the inner thigh on their right leg. For more of a stretch, the individual can lean their body forward (as is indicated by the arrow in FIG. 10) and press their toes on the right leg into the floor and hold for a few seconds, generally less than 30 seconds, for example, about 20 seconds or less. The instructor may direct the individual to switch sides.

Although not shown, stretching the left inner thigh is substantially similar to stretching the right inner thigh, as shown and described above. By way of example, the instructor may direct the individual to place their right foot out in front of them with their left foot over to one side. By pressing their toes into the floor, the individual should feel the inner thigh stretch on the left side. To deepen that stretch, the instructor may direct the individual to move their torso to the right and front. Stretching may be completed while breathing deeply and holding the stretch for a few seconds.

In addition, because the human body has two sets of inner thigh muscles, it may be advantageous to provide another position to stretch the other inner thigh muscles. In one embodiment, and with reference to FIG. 11, the instructor may direct the individual to face and put their right knee on the chair, as shown. The instructor may direct the individual to move their left foot away from their body, i.e., away from the chair. In this position, the individual may feel stretch on their inner thigh, particularly in their right leg. To increase the intensity of the stretch in this area, the individual may lower their torso as is indicated by the arrow in FIG. 11, which may be achieved by simply bending their knee.

In a similar manner, the instructor may direct the individual to place their left leg on the chair with their right leg bent. By slowly bending the right leg and lowering their hips, the individual should feel the stretch on the inner thigh on the left leg. The instructor may direct the individual to breathe and to pull in those abdominal muscles to help support their back while holding this stretch position.

With reference now to FIG. 12, in one embodiment, stretching may include stretching the piriformis muscle. While sitting in the chair, as shown, the instructor may direct the individual to cross their right ankle over their left knee. In this position, the individual may already feel some opening in their right hip. The individual may be limited to this position without causing pain. However, if the individual desires to increase the intensity, the instructor may direct the individual to lean the torso forward and bring the forearms to that leg. The individual may feel the stretch in their hip and in their glute. The instructor may direct the individual to hold that position and breathe while trying not to round their spine and keeping their chest lifted.

Although not shown, the instructor may direct the individual to cross their left ankle over their right knee to perform the same stretch on the left hip. The individual may lean forward with a straight spine and take a few deep breaths to increase the stretch of their left hip. Once the individual is in position, the instructor may direct the individual to hold the stretch for generally less than 30 seconds, typically less than 20 seconds. It will be appreciated that the individual may regulate the amount of stretch by changing the position of their torso relative to their ankle, as is indicated by the arrow in FIG. 12.

With reference now to FIG. 13, in one embodiment, stretching may include the use of the strap 22, described above. By use of the strap 22, each of the individual's hamstrings may be stretched. To that end, the instructor may direct the individual to make a loop in the strap 22 and to put that loop around their right foot. As shown, the individual lies on their back. To begin, both of the individual's legs may be flat against the floor. The instructor may direct the individual to inhale, exhale, and lift their right leg up towards the ceiling. The individual's flexibility may be determined in large part by how high they raise their leg. By holding onto the strap 22 with both hands and keeping the leg straight, the individual may stretch their right hamstring. The instructor may direct the individual that if their knee is bent, then they have gone beyond their current range of flexibility for their hamstring. To properly stretch the hamstring, it may be necessary for the individual to straighten their leg back out and keep their leg straight, i.e., without bending their knee. The instructor may remind the individual that stretching is to the point of tension, not pain.

With reference now to FIG. 14, in one embodiment, stretching may include utilizing the strap 22 to stretch the inner thigh. To do so, the instructor may direct the individual to drop their right foot from the position shown in FIG. 13 to the position shown in FIG. 14, as is indicated by the arrow in FIG. 14. The individual may feel an inner stretch along the inside of that right leg. While breathing deeply, the individual may hold the position shown in FIG. 14 for about 20 seconds.

With reference now to FIG. 15, in one embodiment, the instructor may direct the individual to stretch the outer hip on their right leg. To do so, the instructor may directly the individual to raise their leg from the position shown in FIG. 14 back to an elevated position as shown in the FIG. 13 and then lower their right leg across their body to the position shown in FIG. 15. During this change in positions of the right leg, it may be necessary for the individual to switch the strap 22 from their right hand to their left hand. In the position illustrated in FIG. 15, the individual may feel the outer hip and the glute stretching. The stretch shown may be held for a few seconds, such as about 30 seconds or less, typically about 20 seconds.

Although not shown, the instructor may direct the individual to perform the same stretch but with the left leg. In this regard, the instructor may direct the individual to switch the strap 22 to their left foot and raise their leg to stretch their hamstring as is generally shown in FIG. 13. The instructor may then direct the individual to stretch their inner thigh of their left leg by lowering their left leg towards the floor as is generally shown in FIG. 14. The individual may stretch their left hip by crossing their left leg over the midline of their body as is generally shown in FIG. 15. Each of these stretches may be accomplished by holding the position shown for 30 seconds or less, typically about 20 seconds.

With reference now to FIG. 16, in one embodiment, stretching includes stretching muscles in the lower back. In this regard, the instructor may direct the individual to the position shown in FIG. 16 in which the individual is on their knees with their hands in front. The instructor may direct the individual to point their toes back behind them and sit with their hips down and back as far as they can go. The individual should feel the stretch in their lower back. The instructor may then direct the individual to walk their hands off to the right side (as indicated by the arrow in FIG. 16) as they allow their left hip to drop off to the side. The individual should feel the stretch in their quadratus lumborum, i.e., the low back muscles. The instructor may direct the individual to allow their chest to sink closer to their thighs. As is indicated by the arrows in FIG. 16, the instructor may direct the individual to rotate their hips and hands back to the center, then to rotate their hands to the left, then to move their hips off to the right, and then to sink into that position to stretch the lower back while taking a deep breath and holding the stretch. After stretching, the instructor may direct the individual to move their hands back to the center of the mat and relax their low back muscles.

In one embodiment, the instructor may direct the individual to perform one or more strengthening modality exercises on selected core muscles. Strengthening may occur after performing each of the releasing and stretching modality exercises, as is described above. In one embodiment, strengthening may be performed immediately following the stretching, described above, or may occur a few hours after stretching. In particular, the instructor may direct the individual to strengthen their abdominal muscles. It will be appreciated that strengthening the abdominal muscles will help support the back muscles during movement.

In one embodiment, the individual may lie on their back with their knees elevated as is shown in FIG. 17. The instructor may direct the individual to assume a position in which they have a very natural curve to the low back. That is, the individual should not position the bottom of the rib cage poking up and overarch the low back. In addition, the individual should not be in a position in which their low back is compressed all of the way to the floor. Rather, the individual should have just enough space between the low back and the floor in which to position a grape and not crush it.

When in the position shown in FIG. 17, the instructor may direct the individual to lay their head back and take a few deep breaths, inhaling to expand their rib cage, and exhaling to push the air out of their mouth and feel a corset of muscles engaging from the bottom of the rib cage down into their hips in the front and back of their body. During breathing, the instructor may direct the individual to place their hands by their sides with their palms facing up. Once the individual is in this position, the instructor may direct the individual to take two more deep breaths. On exhale, the instructor may direct the individual to lift their head and look between their knees without pressing their back into the floor. If necessary due to some discomfort in the neck, the individual may place one hand behind their head to support their neck (as is shown in FIG. 18). In this position, the instructor may direct the individual to tighten the corset of muscles of their abdomen to feel compression in their abdomen and pull their navel down to their spine without flattening their low back. This position may be held for a fixed count, for example, generally less than 30 seconds, typically less than 20 seconds.

After placing their feet back on the floor as is shown in FIG. 17, the instructor may direct the individual to lift their right foot up off the floor (as is indicated by the arrow in FIG. 19), and hold their knee right over the hip for a fixed count, typically a 10 count or less, for example, a 5 count. The individual may then place their foot back down to the floor without arching or smashing their back into the mat. The instructor may direct the individual to inhale and exhale and then lift the opposing foot (i.e., left foot) up off the floor to bring the knee in line with the hip while their shoulders are back and down, and they face the ceiling. The individual should feel contractions in the abdomen and hold the position for a fixed count while they inhale and exhale.

In one embodiment, after the individual continues to inhale and exhale, the instructor may direct the individual to bring the right leg back up into a table top position, as is shown in FIG. 20. The instructor may direct the individual to place their left hand behind their head and lift their head and their left shoulder up and cross the left elbow towards the right knee and hold in this position. This does not have to be a big move. The elbow may cross over the midline of the body. The instructor may direct the individual to exhale on the upward movement and inhale on the downward movement while holding their leg in the position shown. The individual may make slow and controlled movements as is indicated by the arrow in FIG. 20. The instructor may direct the individual to repeatedly move from a position in which the shoulder and elbow are down near the mat to the position shown in FIG. 20. The individual should feel the muscles in the abdomen tighten during this repeated movement.

The instructor may direct the individual to reverse their leg positions so that the left leg is in a table top position and the right leg is against the floor. The motions with the elbow are then generally reversed from that indicated in FIG. 20. In particular, the instructor may direct the individual to place their right hand behind their head. While the individual's left leg is in the table top position, they may feel their abdominal wall contract especially around their rib cage. The instructor may direct the individual to hold this position for a few deep breaths while pulling their navel down to the spine but without flattening their back into the floor. After the individual drops their head to the floor, the instructor may direct the individual to perform 10 crunches while inhaling on the tightening of the abdomen muscles and exhaling on the release of the abdomen muscles. The individual's abdomen muscles may fatigue. If so, the instructor may direct the individual to support their leg by holding their leg behind their knee. Once the repetitions are complete, the instructor may direct the individual to lower their head and their foot to the floor.

With reference now to FIG. 21, in one embodiment, the instructor may direct the individual to leave their right leg on the floor and extend their left leg up toward the ceiling, as shown. With their arms out to the sides in a T position, the instructor may direct the individual to drop their left leg out to the side slightly, just far enough to feel the abs engage. The individual should exhale and then bring their leg back to center. While inhaling during the movement out and exhaling during the movement in, the instructor may direct the individual to repeatedly move their leg out and then in, as is indicated by the arrows in FIG. 21. During this motion, the instructor may direct the individual to find a position for their leg in which their back is not aggravated or tense. Accordingly, it may be necessary for the individual to lower their leg or to raise their leg up higher to find this location. During the repetition of this side-to-side movement, the individual may pull their navel down to their spine as they work the leg away from their body. Once the repetitions are complete, the individual may lower their leg to the floor. After inhaling and exhaling, in one embodiment, the individual may be directed to perform the same exercise but with the opposing leg. Specifically, the instructor may direct the individual to pick up the right leg and extend it out to the side. The individual may move the right leg in and out from the upward position as is shown generally in FIG. 21. In one embodiment, the individual may be directed to perform five repetitions of the leg motions described above for each of the left and right legs.

In one embodiment, and with reference to FIG. 22, strengthening may including strengthening the inner thigh muscles in combination with the core muscles. In this regard, the instructor may direct the individual to utilize the small ball 18 to strengthen their inner thighs. Specifically, the individual may place the small ball 18 between their knees. By squeezing the ball 18, the individual should feel the inner thigh muscles tighten. While the individual's head is on the floor, the instructor may direct the individual to pick both feet up off the floor to the position illustrated in FIG. 22. Once in this position, the instructor may direct the individual to position their knees off to one side, e.g., the right side, slightly, but not so far to the right that a hip comes off the floor. The instructor may direct the individual to bring both knees up towards the right shoulder while inhaling. The next position may be to move the knees toward the left shoulder while exhaling with the following position being to move the knees down towards the left hip. This is generally illustrated by the four arrows in FIG. 22. This “around the world” move or clockwise rotation of the knees may be repeated. In addition, the instructor may direct the individual to reverse the rotation (to make a counterclockwise rotation) from that illustrated by the arrows shown in FIG. 22.

With reference to FIG. 23, in one embodiment, the instructor may direct the individual to hold one or more plank positions to strengthen at least the abdominal muscles. To do so, the individual may begin in an all-fours position and then walk their knees back. Then, while keeping their shoulders elevated over their wrists and dropping their hips forward slightly, they arrive in a plank position. FIG. 23 illustrates a plank position in which the full length of the body is maintained in a straight configuration from the knees to the feet with the feet supporting the lower half of the body and with the remaining half being supported by the individual's hands. It will be appreciated, however, that a plank may be performed with the knees resting on the floor such that there is less strain on the abdominal muscles. In the plank position (either off the feet, as shown in FIG. 23, or off the knees, not shown), the abs should tighten without pressure in the low spine. Should the individual feel tightening of the back muscles, it may be necessary for them to move their hips slightly outward. Holding the plank position strengthens the abdominal wall. The instructor may direct the individual to hold this position for generally less than 30 seconds, for example, about 20 seconds or so. The instructor may remind the individual to breathe while in the plank position. Once complete, the individual may move their hips back and walk their knees forward to end this strengthening exercise.

With reference now to FIG. 24, in one embodiment, strengthening includes holding a low plank position. Similar to the plank position shown in FIG. 23, the low plank also strengthens the abdominal muscles. However, the difference between the plank shown in FIG. 23 and that shown in FIG. 24 is that the upper half of the individual's body is supported by their elbows (rather than their hands) with their shoulders positioned over their elbows. As with the plank shown in 23, the instructor may direct the individual to perform the low plank with the lower half of the individual's body being supported by their knees rather than by their feet. Again, the individual should feel their abs tighten, but should not feel pressure in their lower back. The instructor may direct the individual to hold the low plank position for generally less than 30 seconds, for example, about 20 seconds or less.

With reference now to FIG. 25, in one embodiment, strengthening may include holding a side plank. In this regard, the instructor may direct the individual to place their right elbow directly underneath their right shoulder and stack the legs/knees, as shown in FIG. 25. The instructor may direct the individual to move their hips forward so the body is in a straight line while keeping their chin up out of their chest. By lifting their hips off the floor between their elbow and feet, the abdominal muscles, in particular the obliques on that side, should tighten. Although not shown, the side plank position illustrated in FIG. 25 may be performed with the knees in contact with floor rather than having the feet support the lower half of the individual's body. It will be appreciated that performing the plank with the knees on the floor requires less strength, is less intense, and may be easier to perform. In either case, if additional stability is necessary, the individual may place one hand on the floor in front, as shown. While breathing, the side plank position is held for a fixed count that is generally less than 30 seconds, for example, about 20 seconds or less. The instructor may direct the individual to change sides. Thus, once strengthening of the obliques on the left side is performed, another side plank, on the opposing side, is performed to strengthen the obliques on the opposing side.

With reference now to FIG. 26, in one embodiment, strengthening may include a reverse crunch-type exercise. The instructor may direct the individual to position themselves on all fours. In a modified straight arm plank position, in which the right knee rests on the floor, the instructor may direct the individual to bring the left knee toward the left elbow without bending the hips and then return the knee to its original position. This movement is shown by the arrow in FIG. 26. The individual may rest between each repetition. The individual should feel the abs work during movement of the knee. This strengthening exercise may be repeated for 10 times or so. In one embodiment, the opposing side is also strengthened by supporting the body with the left knee and moving the right knee to the right elbow substantially as described above with regard to the left knee. In one embodiment, once strengthening is completed, the instructor may direct the individual to stretch as shown in FIG. 16 and described above.

In one embodiment, after completing each of releasing, stretching, and strengthening modalities, as described above, the instructor may direct the individual to wait 48 hours before repeating each of the releasing, stretching, and strengthening of level 1. Furthermore, it may be beneficial to repeat level 1 at 48 hour intervals until the individual feels as though they have mastered the exercises and the positions of level 1, as described above. Once the individual feels as though level 1 is mastered, the individual may proceed to level 2 as described below.

In general, as described briefly above, in one embodiment of the present invention, the set of instructions may describe multiple levels with each successive level being more intense on the individual's muscles. In one embodiment, the set of instructions further describes a second level of one or more second stages of exercises for each of release, stretch, and strengthen modalities. Generally, the exercise for each of these modalities is more intense than any corresponding exercise of any of the modalities in level 1, described above. For example, during release, the individual may be directed to utilize the ball 16 rather than the cylindrical roller 14, and rather than using the ball 16, the individual may be directed to use the small textured ball 18. Accordingly, in one embodiment, the kit 10 includes the small textured ball 18, which provides a more intense pressure on the individual's muscles, and the set of instructions further includes instructions for the individual to perform one or more of releasing, stretching, and/or strengthening stages in the second level.

In one embodiment, and with reference to FIG. 27, the instructor may direct the individual to utilize the ball 16 rather than the roller 14 in a position substantially similar to the position shown in FIG. 3 during release as described above for the initial level of exercises. With reference to FIG. 27, the instructor may direct the individual to position the ball between the front of the right hip and floor and to control the pressure between the ball 16 and the right hip by resting part of their body weight on their forearms and on their feet. In other words, all of the individual's weight is not on the ball 16. Rolling forward and backward on the ball 16 as is indicated by the arrow in FIG. 27 releases tension in the hip flexor. Specifically, rolling the ball from the crease at which the thigh meets the hip and then up to the hip bone massages the hip muscles. The instructor may direct the individual to roll back and forth while taking a few deep breaths. As in the level 1 release exercises, the instructor may direct the individual to find a hotspot in the hip flexor and to hold the ball 16 stationary on the location for generally less than 30 seconds, for example, about 20 seconds or so. The instructor may then direct the individual to switch hips and position the ball 16 under the left hip. By moving backward and forward on the ball 16 along the left hip flexor, while taking deep breaths, the individual may release tension in the left hip flexor in this location. And, the instructor may direct the individual to find a hotspot on the left hip and hold the pressure on that location for a fixed amount of time, generally less than 30 seconds, for example, 20 seconds or so. The individual may feel that area heating up and any discomfort that the individual might feel could either be localized or spread to other parts of the muscle or adjoining muscles.

In one embodiment, releasing may include a similar rolling exercise as set out above with respect to FIG. 4 to release tension from the tensor fasciae and the IT band. However, the full range of rolling in level 2 may include a larger portion of the muscle between the knee and the hip. Specifically, the instructor may direct the individual to roll slowly on the roller 14 from near their knee, but staying away from the joint, to their hip and then reverse the rolling motion by rolling from the hip back toward the knee. The instructor may direct the individual to repeatedly roll back and forth. The instructor may direct the individual to locate a hotspot and then put pressure on the hotspot with the roller 14 to release tension from that trigger point. By holding the roller 14 on the hotspot, the tension may be released from the muscle. The instructor may direct the individual to switch sides. Once again, the individual may begin with the roller 14 at a position that is close to their knee and end near their hip. Even though a trigger point might be in just one small area of the muscle, it often affects the entire muscle, as well as some of the other connective tissues of the body. Thus, it will be appreciated that rolling on this location places pressure all along the IT band, including on the trigger points. Nevertheless, in one embodiment, the instructor may direct the individual to identify a trigger point and then place the roller 14 on the trigger point. The instructor may then direct the individual to hold the roller 14 on that location to release tension in the muscle. The instructor may direct the individual to breathe deeply. The individual may find themselves sweating, which is perfectly normal.

With reference to FIG. 28, in one embodiment, releasing may include placing pressure on the gluteal muscles with the ball 16. It will be appreciated that rolling the ball 16 on the gluteal muscles places pressure on the gluteus medias. The instructor may direct the individual to put their body weight partly on their hands, to turn their left toe and left knee out, and to roll on the ball 16 away from the middle of their glute up towards their hip bone, as indicated by one set of arrows in FIG. 28. And, in one embodiment, the instructor may then direct the individual to roll side to side (as indicated by a second set of arrows in FIG. 28) and then up and back. This motion places rolling pressure on the hotspots in this muscle. The instructor may then direct the individual to identify a hotspot and place stationary pressure with the ball 16 on that hotspot while breathing deeply. It will be appreciated that the individual may control the amount of pressure on the ball by placing more weight on their hands to take some pressure off that gluteus medius. Alternatively, the individual may allow their body to sink further down on the ball 16 for a deeper massage. Once the releasing of the left glute is performed, the individual may switch to the right glute. The individual may rotate the ball to the other glute, angle their knee and toe out and roll out their right side. Rolling from side to side and up and back with very subtle controlled movements also keeps the abs engaged. Once again, the instructor may direct the individual to locate and place stationary pressure on a trigger point.

With reference now to FIG. 29, in one embodiment, releasing includes using the roller 14 to place pressure on a hamstring. In particular, the instructor may direct the individual to place the roller 14 behind and just above the left knee on the lower portion of hamstring and to cross the right ankle over the left ankle. Neither foot may touch the floor. The individual may lift their hips up off the floor while supporting their upper body on their hands to roll out their hamstring. The rolling motion may begin near the knee and end near the glute. The back-and-forth motion, as indicated in FIG. 29, may be repeated. By rotating the toes slightly, the pressure point between the roller 14 and the hamstring may be changed while rolling with the back-and-forth motion. The same rolling motion with the roller 14 may be utilized on the right leg. The individual may cross their left ankle over the right ankle with the roller positioned under the right hamstring. The individual may adjust the pressure on their muscle by transferring some of their body weight to or from their hands. The instructor may direct the individual to point their toes straight up towards the ceiling and then to rotate their toes out while continuing to roll the hamstring. The back-and-forth rolling motion may be repeated.

With reference to FIG. 30, in one embodiment, releasing includes applying pressure or rolling the quadratus lumborum, that is, the low back muscles. In particular, the instructor may direct the individual to rotate onto their left hip and place the roller just above the hip, but below the rib cage, as is shown in FIG. 30. The individual's torso may be slightly rotated or in an angled position to keep the roller off their spine. The rolling motion may include rolling on the roller 14 back and forth, as indicated by the arrow in FIG. 30, between the left hip and the rib cage. The individual may adjust the pressure on the muscle by lifting their hips up off the mat as they roll from the bottom of the rib cage to the top of the hip. It will be appreciated that with the roller 14, the individual is placing pressure on the more superficial of the trigger points usually found in the quadratus lumborum. The instructor may direct the individual to find a hotspot and hold the roller 14 stationary on that position while taking a few deep breaths. Once rolling of the left side is performed, the individual may switch to the other side. Similar to the left side as set out above, in a slightly rotated position, the individual may roll the roller 14 from the hip to the rib cage while staying off of the spine. The instructor may direct the individual to inhale and exhale during each roll. Once rolling is performed, the instructor may direct the individual to find a trigger point and press the roller 14 against it for a fixed time generally less than 30 seconds, for example, 20 seconds or less.

With reference to FIG. 7, in one embodiment, releasing includes applying pressure to the glutes with the ball 16 to place pressure on the piriformis muscle. This release exercise may be similar to the release exercise described above with regard to the exercises for level 1 though, according to embodiment of the present invention, it may be repeated in level 2. As shown, the individual may sit on the ball 16 and roll back-and-forth motion across the middle of the glute (as indicated by the arrow in FIG. 7), from the tailbone area out to the hip. The instructor may direct the individual to turn their left toe out to help target more deeply inside the piriformis. It will be appreciated that the individual may adjust the pressure on the ball by placing more or less pressure on their hands and feet. The instructor may direct the individual to find a hotspot and sit with the ball 16 applying pressure to that spot. It will be appreciated that the discomfort associated with applying pressure to the hotspot may be only momentary, but may provide the individual with hours, days, or decades of pain relief. The individual may then switch the ball 16 to the other side to apply pressure to that piriformis muscle in substantially the same manner.

With reference now to FIG. 31, in one embodiment, releasing may include using the ball to place pressure on the erector muscles. In this regard, the individual may position the ball 16 on their back just off to the left of the spine. By laying back on the ball, the individual may apply pressure to the erector muscles that run along the left side of the spine. The instructor may direct the individual to roll across the ball 16 by moving their hips down and then back up, as is generally indicated by the arrows in FIG. 31. By rolling from the hip towards the shoulder blade, it is possible to apply pressure to the muscles in this area. The instructor may direct the individual to find a hotspot and apply direct stationary pressure with the ball 16 to that area. The individual may adjust pressure on the muscle by moving their feet away the ball 16 if they need more pressure and moving their feet toward the ball 16 if they need less pressure. Once rolling of the erector muscle on one side is performed, the individual may then roll the erector muscle on the other side. In this regard, the individual may roll the ball 16 starting at a position near the hips and then rolling the ball 16 towards the shoulders. This rolling motion may be repeated. The instructor may direct the individual to locate a hotspot and position the ball 16 to apply pressure to that hotspot for a fixed period of time generally less than 30 seconds, for example, less than 20 seconds or so.

With reference now to FIG. 32, in one embodiment, releasing includes applying pressure to the inner thigh muscles. Specifically, the individual may place the ball 16 between their inner thigh and the chair. The individual may start with the ball 16 under the upper part of the right thigh, as shown. The individual may immediately feel some tension when pressure is placed on the inner thigh with the ball 16. After a few seconds, the instructor may then direct the individual to stand up and place the ball 16 closer to the knee and allow their body weight to sink into the ball 16 at this location. It will be appreciated that as the adductor muscles and inner thigh muscles start to release tension, the individual may then begin to identify one or more trigger points. The individual may move their knee relative to the midline of their body to change the pressure on the muscle, as is indicated by the arrows in FIG. 32. The instructor may direct the individual to repeatedly bring their knee in and out while on the ball 16. It is thought that the inner thigh muscles get highly aggravated and may be short, and when there are trigger points and short muscles in the inner thigh, this tension may refer pain to the low back. So while the position shown in FIG. 32 may be uncomfortable, releasing tension in the inner thigh is important to pain reduction/relief in the low back. Once releasing of tension from the inner thigh on one side is performed, the individual may then switch to the other inner thigh. The individual may then use the ball 16 to release tension in substantially the same manner as described above on the remaining inner thigh. During releasing with the ball 16 on the inner thigh, the individual may tighten their abdominal muscles to help support their spine. The individual should also breathe steadily during releasing.

As with level 1, following releasing of tension in the muscles as is described above in conjunction with FIGS. 27-32, in one embodiment, the individual's muscles are then stretched. The timing of stretching after releasing may be similar to that described above in level 1. With reference to FIG. 33, stretching may include stretching the inner thigh muscle. According to the stretch shown in FIG. 33, the individual may feel the inner thigh stretch from the knee all the way up to the groin area in their right leg. To do so, the instructor may direct the individual to position their left foot out to one side with their opposing leg bent at the knee. To enhance the stretch, the individual may direct their baby toe side of their foot upward while leaving their big toe side of the foot down on the floor. To adjust the intensity of the stretch, the individual may place their left hand onto their left thigh to transfer some of their body weight to this position. The individual may hold the stretch for a few seconds, generally less than 30 seconds, for example, less than about 20 seconds or so. The inner thigh of the left leg may be similarly stretched.

With reference to FIG. 34, in one embodiment, stretching includes stretching the piriformis. Using the chair, the instructor may direct the individual to take a position called the pigeon pose. To do so, the individual may place their right hand on the back of the chair and their left hand on the seat of the chair, as shown. By placing their right knee on the chair and then bending their right knee with their left leg extended, the individual may lean forward into the stretch. The individual may begin to feel the glute stretch on the right side by letting their body weight sink into the chair. The instructor may direct the individual to pull in their abs and their navel back towards their spine so that their lower back is not being compromised. The stretch may be held, while breathing deeply, for a few seconds generally less than 30 seconds, for example about 20 seconds or less. The individual may then switch sides to stretch the piriformis on the opposing side in substantially the same manner as set forth above with reference to FIG. 34.

With reference now to FIG. 11, in one embodiment, stretching includes stretching the inner thigh muscles. This stretch is substantially the same as the stretch described above with respect to FIG. 11, but may be repeated in level 2 with the only variation being that it is more intense. To increase the intensity, the instructor may direct the individual to step the left foot away from the chair, bend the left knee, and lean their body away from the chair as is indicated by the arrow in FIG. 11. This is a deep inner thigh stretch. The individual may even feel the stretch coming up the front of the hip. The individual may then stretch the inner thigh of the left leg in substantially the same manner as described above with regard to the inner thigh of the right leg.

With reference to FIG. 35, in one embodiment, stretching further includes stretching muscles in the hip, including the tensor fasciae. As shown, in a standing position with their feet about hip distance apart, the instructor may direct the individual to place their right foot over their left foot. With each foot flat and firmly on the floor, the individual may push their hips out to the left side. The individual may begin to feel a stretch on that outer hip. The instructor may direct the individual to rotate the hip forward or backward to find the most intense stretch of the hip and, once found, the individual may hold the stretch for a few seconds, generally less than 30 seconds, for example, about 20 seconds or less. It will be appreciated that the tensor fasciae is connected to the IT band and can refer pain down to the knee when it gets too tight. So, treating the hip muscles may help reduce pain in other areas of the body. The instructor may direct the individual to switch legs crossing their right leg over their left leg to stretch the muscles in their right hip. By pushing their hips out to the right side, the individual may stretch the muscles of their right hip. The individual may hold the stretch for a few seconds as described above.

With reference to FIGS. 13-15, in one embodiment, stretching further include stretching the hamstrings with the strap 22. Stretching the hamstrings in level 2 may be substantially similar to stretching the hamstrings, as described above in level 1.

With reference to FIG. 36, in one embodiment, stretching includes stretching the muscles of the hip. The instructor may direct the individual to place their right foot out in front and then lean the right knee forward, as is indicated by the arrow in FIG. 36. The individual may feel a stretch of their left hip. The individual may place their right elbow on their right thigh and may feel the stretch while holding their navel in so as to not compromise the lower back. The individual may hold the stretch for a few seconds, generally less than 30 seconds, for example, about 20 seconds or so. The individual may stretch their right hip by switching the positions of their legs and preceding in a manner substantially the same as described above.

With reference to FIG. 37, in one embodiment, stretching may further include stretching the inner thigh and lower back, as shown. The individual may place their hands on the mat and extend their left foot out to one side. While keeping their left leg straight, the instructor may direct the individual to take their hands off the left side of the mat and then sit their hips down and back. While letting their body weight sink into the mat, the individual may stretch out the right side of the low back. By adjusting the position of their foot, the individual may adjust the intensity of the stretch. After holding the stretch for a few seconds, the individual may switch sides and stretch the inner thigh of the right leg and the left side of the lower back in substantially the same manner.

Following stretching of the muscles, as is described above, in level 2, in one embodiment, the individual is directed to strengthen their core muscles. With reference to FIG. 38, strengthening may include exercising the abdominal muscles. As described above in level 1, the corset of core muscles wraps from the back all the way to the front. While lying in the position shown in FIG. 38, the instructor may direct the individual to exhale as they force the air out of their mouth so as to compress the muscles of the abdomen, tightening that corset of muscles. The individual may directly focus on the “six pack” of abdomen muscles by lifting their head and holding their head in this position, as shown. While keeping the core set of muscles taut, the individual may hold this position for a few seconds.

While keeping the left leg flat along the ground, the instructor may direct the individual to bring their right leg up into a 90 degree bend at the knee and at the hip, as shown in FIG. 39. The instructor may direct the individual to inhale and press their leg out at an angle elevated above the floor (not shown). After a brief hold and exhale, the individual may move their leg back to the 90° position shown in FIG. 39 and inhale. This back-and-forth motion between an angled, extended leg position and the 90° position, shown in FIG. 39, may be repeated. The individual may feel abdominal engagement above their right hip. A further modification may include extending the leg out to an angled position from the 90° position and then dropping the leg from the angled position to the floor. The instructor may direct the individual to then raise their leg from the position near the floor to the angled position and then bring the leg back to the 90° position. Thus, three leg positions may be utilized to strengthen the abdominal muscles. This three-position motion may be repeated. Once strengthening of the right leg is performed, the individual may repeat the strengthening exercise as described above with the left leg.

With reference now to FIG. 40, in one embodiment, strengthening includes strengthening the muscles between the rib cage and the hip. With the leg in the elevated position shown in FIG. 40, the individual may trace small circles (about the size of a dinner plate) with the right leg, as is indicated by the arrow in FIG. 40. The individual may feel the muscles between the rib cage and the hip on the right side of the body tighten. The instructor may direct the individual to rotate their leg for a 10 count or so. Once strengthening of the right leg is performed, the instructor may direct the individual to strengthen the muscles associated with their left leg in the substantially similar manner as set forth above with reference to FIG. 40.

With reference now to FIGS. 23, 24, and 25, strengthening may include performing planks (e.g., high plank, low plank, and side plank, respectively), as described above with reference to level 1 strengthening. Generally, the intensity of each plank position shown is increased relative to level 1. In this regard, the planks performed in level 2 are generally performed with the feet supporting the lower body (as shown), rather than the knees, which is more typical of level 1. Specifically, during strengthening of level 2, the individual may hold any single one or each of the planks shown in FIGS. 23, 24, and 25 for a few seconds.

With reference now to FIG. 41, in one embodiment, strengthening includes a modified, elevated plank position. The instructor may direct the individual to place their forearms on the seat of the chair in the position shown. Once in the position, the individual may bend the right knee and then the left knee while holding this elevated plank. Movement of the right knee is indicated by the arrows in FIG. 41. The instructor may direct the individual to not let their hips drop when bending their knees. After straightening the right leg, the individual bends their left knee. While continuing to breathe, the individual alternately bends the right knee and then the left knee. This alternating bending of the knees in the elevated plank position may be repeated. In one embodiment, once strengthening is performed, the individual may perform a stretch, such as that shown in FIG. 16 and described above.

In one embodiment, the instructor may direct the individual to perform exercises for each of the release, stretch, and strengthen modalities two to three times a week with at least one day of rest in between. Once the individual is believed to have mastered the modalities of level 2, they may proceed to level 3 which includes exercises for each modality that are a little more challenging and a little more intense than the exercises of either of level 1 or level 2.

In general, as described briefly above, in one embodiment of the present invention, the set of instructions may describe multiple levels with each successive level being more intense on the individual's muscles. In this regard, in certain release modality exercises, the individual may be directed to use the ball 16 rather than the cylindrical roller 14, and rather than using the ball 16, the individual may be directed to use the small textured ball 18. Thus, in each instance, the individual may be directed to use a smaller tension releasing device 12 relative to level 1 or level 2. It will be appreciated that the smaller tension releasing device 12 provides a more intense or higher pressure on the individual's muscles during release.

In particular, in one embodiment of the present invention, the method for physical therapy includes a third level of intensity, i.e., level 3. In this embodiment, the set of instructions further includes instructions for the individual to perform one or more of the exercises for each of the release, stretch, and strengthen modalities. The exercises are generally more intense than any corresponding stages of level 2, described above. For example, in level 3, the small textured ball 18 of the plurality of tension release devices provides the greatest amount of pressure on the muscles during the release exercises.

In view of the above, and with reference now to FIG. 42, in one embodiment, releasing includes placing pressure on the individual's muscles similar to that disclosed above with regard to releasing tension described in levels 1 and 2, but differs in that the individual utilizes the smaller tension releasing devices 12 to produce greater pressure on their muscles. As shown in FIG. 42, releasing may include placing pressure on the left hip flexor muscles on the small textured ball 18. In this regard, the instructor may direct the individual to place their right hip on top of the small textured ball 18 and to let their entire body weight sink into the ball 18 and to move forward or backward until they find a trigger point. It will be appreciated that the small textured ball 18 will allow the individual to pressure a little deeper into the individual's muscles. During releasing with the small textured ball 18 positioned on the hip, the individual may not initially roll on the ball 18. Rather, the instructor may direct the individual to find a trigger point and hold pressure with the small ball 18 on that trigger point for a fixed amount of time, generally less than 10 seconds, for example, for a five count or so. The individual may then switch the ball 18 to their other hip (e.g., their left hip) and then repeat releasing the trigger points as described above. For either hip, if the pressure is too great, the individual may turn their toes under and lift their leg to reduce the pressure. To increase the pressure, the individual may allow more of their weight to be supported by the ball 18.

With reference now to FIG. 43, in one embodiment, releasing may include rolling on the ball 16. As shown, the individual may lay on the ball 16 and roll the ball 16 to apply pressure to their tensor fasciae muscle. If the individual did not spend enough time releasing with the larger tension releasing devices 12 in previous levels, the intensity of discomfort in this releasing exercise may be too great. The instructor may direct the individual to start the ball 16 by their knee and to roll their body over the ball 16 so that the ball 16 rolls towards their hip. The instructor may further direct the individual to pay attention to where the tightest spot is in their tensor fasciae muscle, which is closer to their hip than to their knee. Rolling on the ball 16 between the hip and the knee may be repeated. The instructor may then direct the individual to locate a hotspot and place pressure with the ball 16 directly on that location for just a few seconds and then remove the pressure. The individual may then roll on the ball 16 along this portion of the leg at least one more time before switching to their other leg. The individual may then roll the ball 16 along the other side in substantially the same manner as described above with regard to FIG. 43.

With reference to FIG. 44, in one embodiment, releasing includes rolling the individual's gluteal muscles on the small textured ball 18. To do so, the instructor may direct the individual to place the small textured ball 18 on the area just below the top of the individual's hip bone. By placing their bodyweight on the ball 18 in this location and rolling back and forth, tension is released in the gluteal muscles. The individual may adjust the pressure on the ball by resting back on their hands. Alternatively, for more pressure, the individual may straighten their arms and lean back onto their elbows and forearms, as shown. Rolling may include a side-to-side motion (as is indicated by the arrows in FIG. 44) produced by the individual swinging their hips in a side-to-side motion. Following rolling, the individual may apply stationary pressure to a hotspot for a few seconds with the ball 18. Generally, holding the pressure on the hotspot may be for ten to fifteen seconds. If more pressure is desired during the hold, the individual may let their left knee open up to their side. Once releasing is performed on one side, the individual may switch the ball 18 to the opposing side and releasing may be performed on their other side in substantially same manner as described above and shown in FIG. 44.

With reference now to FIG. 45, in one embodiment, releasing includes rolling the small ball 18 on the muscles in the lower back. The instructor may direct the individual to place the small ball 18 above their hip bone. Rolling may include rolling the small ball 18 on the muscles between the top of the hip bone and the spine. It will be appreciated that the small ball 18 may allow the individual to locate and put pressure on trigger points in the quadrates lumborum not possible with the ball 16 or the roller 14. The individual may roll the ball 18 towards their spine, but not onto the spine itself, and then roll the ball 18 back over towards their hip. This back-and-forth motion, as is indicated by the arrows in FIG. 45, may be repeated.

In one embodiment, rolling includes placing pressure on the muscles in the back near, but just below, the rib cage. The ball 18 should not touch the rib cage. The individual may feel pressure on their quadrates lumborum. The instructor may direct the individual to breathe while placing pressure on that muscle and may direct the individual to slowly rotate the hips around to bring the ball 18 closer to the spine, but not on their vertebrae. Rolling may further include rolling the small ball 18 up and down generally parallel to the spine while rotating the hips forward and backward to locate a hotspot. The individual may apply stationary pressure on the hotspot for fifteen seconds or so while breathing deeply. Once rolling the ball 18 on one side is complete, the individual may switch sides and repeat rolling the ball 18 on the other side in substantially the same manner as described above with reference to FIG. 45.

With reference now to FIG. 46, in one embodiment, releasing includes rolling the hamstrings on the ball 16. To do so, the individual may place the ball 16 under the left hamstring, as shown. Starting high up on the left hamstring, the individual may place a portion of their body weight onto the ball 16. The individual may pull their hips back to roll the ball 16 toward their knee and then push their hips forward to roll the ball 16 towards their hip. This back-and-forth motion, as indicated by the arrows in FIG. 46, may be repeated. The instructor may direct the individual to identify a hotspot with the ball 16 during rolling. Once identified, the instructor may direct the individual to switch to the small ball 18 to apply stationary pressure to that hotspot for a few seconds. As is shown in FIG. 47, the individual may apply pressure to the hotspot with the small ball 18 identified during rolling with the ball 16 as described in conjunction with FIG. 46, above. The individual may apply pressure with the small ball 18 to the hotspot for a few seconds. Additional pressure may be applied by crossing the right foot over the left leg and sinking down onto the ball 18. Once the individual releases tension in the hamstring with one or both of the balls 16 and 18, as described above, the individual may switch sides and begin releasing by rolling the right hamstring on the ball 16 followed by direct application of pressure to a hotspot with the small ball 18 in substantially the same manner as described above with reference to FIGS. 46 and 47.

With reference now to FIG. 48, in one embodiment, releasing may include placing pressure on the calf muscles. To do so, the individual may place pressure on the left calf with the small ball 18. The small ball 18 may be placed under the left calf, just below the knee, but not under the knee itself. The individual may adjust pressure on the ball 18 by crossing their right leg over their left leg. The individual may roll on the ball 18 by pulling and pushing their hips in a back-and-forth motion, as is indicated by the arrows in FIG. 48. This back-and-forth motion may be repeated a few times along the upper calf. Once the individual has released tension in the upper calf, the individual may move the ball 18 to the lower calf. And again, the individual may push and pull their hips in a back-and-forth motion to roll the ball 18 along the lower calf of their leg. The instructor may direct the individual to identify a hotspot, and then apply direct pressure with the ball 18 to that location for a few seconds. Once the tension in the upper and lower calves is released, the individual may switch the ball 18 to the other upper calf and then lower calf on the right side and release tension with the ball 18 on their right side in substantially the same manner as described above.

With reference now to FIG. 49, in one embodiment, releasing includes applying pressure to the gluteal muscles with the small ball 18. In particular, releasing may include applying pressure to the piriformis with the small ball 18. To do so, the individual may sit on the small ball 18 in the middle of their glute on their left side. It will be appreciated that individuals who do a lot of sitting may benefit from this release exercise but may feel some discomfort when pressure is placed on the glute with the small ball 18. The instructor may direct the individual to rotate their knee to the side as they sink onto the ball 18 positioned in the middle of the glute. It is known that the piriformis runs from close to the tailbone to the outer side of the hip. To target this muscle, the individual may roll from side to side, as is generally indicated by the arrows in FIG. 49, putting as much of their body weight on the ball 18 as they can tolerate. The rolling back-and-forth motion may be repeated. Once rolling is performed, the individual may identify a hotspot on which the individual may apply direct stationary pressure with the ball 18 for a few seconds. The individual may then switch the ball 18 from the left gluteal muscle to the right gluteal muscle and may roll back-and-forth and then hold the ball 18 on the right piriformis in substantially the same manner as described above with reference to FIG. 49.

With reference now to FIG. 50, in one embodiment, releasing may include placing pressure on the inner thigh with the small ball 18. To do so the individual may sit on the small ball 18 when the small ball 18 is placed on a chair, as shown. While sitting on the small ball 18, the individual may rotate their hips back and forth so that they place pressure on their inner thigh muscles, particularly in the adductor muscles, with the small ball 18. The individual may reduce the pressure on the ball 18 by pressing their hands into the chair. For more pressure, the individual may allow their body to sink into the small ball 18 while using their hands for balance. The individual may vary the pressure by rotating their torso. In addition, the instructor may direct the individual to move the ball 18 closer to the groin area and then hold the pressure on that location for a few seconds. Once the individual releases tension in their right inner thigh, the individual may switch the small ball 18 to the left inner thigh and releasing may be performed in substantially the same manner as set forth above with reference to FIG. 50.

With reference to FIG. 51, in one embodiment, releasing includes placing pressure on the muscles just under the shoulder blades. To do so, the individual may place the small ball 18 between the chair and their back just below their shoulder blades. The individual may move forward and backward pressing against the ball 18. After identifying a trigger point, the individual may press the ball 18 to that location and hold the pressure there for a few seconds. After a few seconds, the individual may switch the ball 18 to the left side of their back and may place pressure on the muscles located just under the shoulder blade in substantially the same manner as set forth above with regard to FIG. 51.

As with the previous levels, in one embodiment, level 3 includes stretching the individual's muscles, particularly those treated during releasing, as set out above with reference to FIGS. 42-51. And, as with releasing in level 3, stretching is more intense in level 3. In this regard, the instructor may direct the individual to be cautious to make sure the individual is stretching to the point of tension and not to the point of pain.

To begin level 3, in one embodiment, stretching includes stretching the muscles of the hip. With reference to FIG. 52, the individual places their right foot in front while bending their knee and extending their left leg to the rear, as shown. The individual's left heel may lift off the ground. By bending their right knee, while keeping it in line with their ankle, and straightening their left leg, the individual may feel a stretch of the front of the left hip. The individual may place their hands on the top of their right thigh, as shown. The instructor may direct the individual to keep their toes spread in both feet to help with their balance. In addition, the instructor may direct the individual to take a deep breath and then extend their left hand up through the midline of the body over their head (this position is not shown) to increase the stretch in the front of their hip. After a few deep breaths, the individual may switch to stretch their right hip in substantially the same manner as described above with reference to FIG. 52. It will be appreciated that if there is any discomfort in the individual's low back, they can rotate forward with their chest to straighten out their spine. Otherwise, the individual should keep their chest and their shoulders back while breathing.

With reference to FIG. 53, in one embodiment, stretching includes stretching the inner thighs. To do so, the individual may take the position shown in FIG. 53 with their knees spaced apart on the ground wider than their shoulders and may support themselves with their hands on the floor. The individual's toes may point out to the sides, as shown. The instructor may direct the individual to put some of their body weight on their hands and begin to set their hips down and back, as is generally indicated by the arrow in FIG. 53. In addition, the instructor may direct the individual to walk their hands toward their body so that they feel the stretch on their inner thighs and in the front of their hips. To reduce the intensity of the stretch, the individual may walk their hands forward and lift their hips up slightly. To increase the intensity of the stretch, the individual may walk their hands back and sit the hips lower. Once in position, the individual may hold the stretch for a few seconds, opening both sides of their body and letting their hips get a little bit looser, which may allow them to move a little more freely and with reduced pain.

With reference to FIG. 54, in one embodiment, stretching may include stretching the quadriceps in each leg. To do so, the individual may lay down on their left side and bring their right heel towards the right glute. The instructor may direct the individual to take their left foot and place it above their right knee on their right thigh, as shown in FIG. 54. By angling their right or top knee down towards the floor, the individual should feel the muscle stretch in the hip, as well as, in the front of the right thigh. After a few seconds of holding the stretch, the individual may stretch the left side. To do so, the individual may lie on their right side and bring their left heel back towards the left glute. By applying downward pressure with the right foot, the individual may feel the stretch in the hip and potentially all the way down the side of the leg towards the knee. After holding the stretch for a few seconds, the individual may release the stretch.

With reference to FIG. 55, in one embodiment, stretching may include stretching the piriformis and hip muscles. To do so, the individual may begin on all fours and then bring their right knee toward their right hand with the right foot positioned by their left hip and turn their left toes under, as shown. By dropping their right hip toward the floor, the individual may feel the hip and the glute muscles on their right side stretch. After a few seconds, the individual may relax and then move their right foot away from the left hip (this position is not shown). In this modified stretching position, the individual may move their hands to their front and gradually away from their body to increase the stretch. To further increase the stretch, the individual may place their forearms on the floor in front of them and sink their head, shoulders, and chest toward floor. After holding this position for a few seconds, the individual may switch sides and stretch the left glute and the hip muscles in substantially the same manner as the right glute and the hip muscles, as described above, but with their leg positions reversed.

With reference now to FIG. 16, in one embodiment, stretching may include stretching the lower back from the child's pose as is described above in level 1.

With reference now to FIGS. 13, 14, and 15, in one embodiment, stretching may include stretching the hamstrings with the strap 22, as described above with reference to the stretching of level 1. Thus, level 3 stretching may include stretching the hamstrings according to one or more of the positions shown in FIGS. 13, 14, and/or 15, each described above. It will be appreciated that stretching may be intensified in this level by bringing the legs further forward or to each side to a greater degree than in either level 1 or level 2.

With reference to FIG. 56, in one embodiment, stretching may include stretching the low back. To do so, the individual may lie on the ground and, with their right knee bent, bring their right knee over their left leg, which is flat on the floor. The individual's arms may be in a T position, as shown. The individual should feel a stretch in their low back. The instructor may direct the individual to twist as much as possible but without causing discomfort in their low back. Furthermore, if this stretch is uncomfortable, the individual should move out of this position. Otherwise, the individual may stretch for a few seconds while letting their knee drop toward the floor. To produce a more intense stretch, the individual may take their left hand and gently press their right knee down towards the floor. After a few seconds, the individual may release the stretch and switch to their left side. The stretch may be repeated on the left side in substantially the same manner as described above with reference to FIG. 56 but with the legs reversed.

Following stretching of the muscles in level 3, as is described above, in one embodiment, the set of instructions include instructions for strengthening the individual's core muscles. As described above, the individual may engage their corset of core muscles prior to moving. That is, prior to moving, the individual may secure the spine to keep those vertebrae in line by activating the core muscles. With reference to FIG. 7, strengthening may include exercising the abdominal muscles after engaging the core muscles. While the individual lies flat on the floor, the instructor may direct the individual to lift their head and then bring their left knee up toward their body, as is indicated by one arrow in FIG. 57. The right leg remains flat on the floor. The individual may rotate their torso toward the knee (as shown by the other arrow in FIG. 57) while squeezing their knee into a crunched position. After a brief pause in the upward position, the individual may extend their left leg out and down while rotating their torso toward the floor and extending their arms and hands overhead (this position is not shown). In this extended position, the individual's arms and legs are generally extended to a position parallel to the floor. After extension, the individual may once again bring their left knee toward their torso while lifting their torso and head off the floor back to the crunch position shown in FIG. 57. In conjunction with inhaling on the extension and exhaling on the crunch, the individual may repeat the move to strengthen their abdominal muscles. On the last repetition, the individual may hold the crunch position for a few seconds, for example, about 5 seconds. Once the individual performs strengthening with their left leg, the individual may switch to their right leg and perform similar movement to strengthen the abdominal muscles on their right side.

With reference now to FIG. 58, in one embodiment, strengthening may include performing crunches. To perform this crunch, the individual lifts their feet up and turns their knees out but leaves their heels together, as shown. The individual then reaches their hands around each side of their left thigh to touch their hands together on the hamstring side of their left leg, as shown. After touching their hands together, the individual rolls their torso back to the floor and moves their hands away from their left hamstring while leaving their legs in the position shown, thus completing the crunch. The crunch is repeated while exhaling on the crunch and inhaling when lowering their torso back to the floor. If necessary, the individual may take one hand to support their neck during the crunch. The individual may perform a similar crunch by reaching around their right leg while lifting their torso. The crunch may be repeated the same number of times on the right as on the left side.

With reference to FIGS. 23 and 24, in one embodiment, strengthening may include performing a combination of the high plank and the low plank, respectively. In particular, the individual may start from the high plank position (FIG. 23) and then drop to the low plank position (FIG. 24) and then return to the high plank position. It will be appreciated that this is very intense core work. It can be modified and done on the knees, if necessary. In one embodiment, the individual may lead with the right hand by placing their right forearm down and then dropping their left forearm down so that they are in the low plank position (FIG. 24). Once in the low plank position, the individual may use their right hand to push up and then use their left hand to push themselves to the high plank position (FIG. 23). The up-and-down process may be repeated while exhaling when pushing up to the high plank position, inhaling when dropping to the low plank position and keeping the back generally flat during the up and down moves. The instructor may direct the individual to stretch and relax in the child's pose, as shown in FIG. 16 and described above, following this strengthening exercise.

With reference to FIG. 59, in one embodiment, strengthening may include a modified plank. In particular, starting in the low plank position shown in FIG. 24, the instructor may direct the individual to step their left foot out to one side, transfer their weight to that foot, and then step the right foot out, as is generally shown by the arrows in FIG. 59. Each of their left foot and their right foot are then returned to the midline of their body to resume the low plank position shown in FIG. 24. The process is repeated multiple times by moving the left foot and then the right foot out and then returning them to the midline. In addition, it will be appreciated that it is possible to perform the strengthening exercise by leading with the right foot.

With reference to FIG. 60, in one embodiment, strengthening may include performing an arm and leg lift. Specifically, starting from an all-fours position, the individual may extend their right fingertips and the left toes away from each other, as shown by the arrows in FIG. 60. While breathing, the individual may repeat the arm and leg lift multiple times, for example, 6 times. The exercise may be performed with the left hand and the right leg in substantially the same manner. The instructor may direct the individual to stretch and relax in the child's pose, as shown in FIG. 16 and described above, following this strengthening exercise.

With reference to FIG. 61, in one embodiment, strengthening may include performing a reverse crunch. To perform the crunch, the individual may begin on all fours and then move into a high plank position (shown in FIG. 23). Once in the high plank position, the individual may put their weight on their right foot and bring their left foot toward their chest to a crunch position and then extend their left leg back out to resume the high plank position to complete the crunch. During movement of the leg, the individual may not move their hips too much. This strengthening exercise may be performed multiple times. Once strengthening is performed on one side, the individual may switch legs and perform the crunch on the opposite side in substantially the same manner.

With reference now to FIG. 62, in one embodiment, strengthening includes a modified side plank. Starting from the position shown in FIG. 25, the individual may bring their left foot out in front of their body and tap that foot on the floor and then return their left foot to the side plank position. This exercise may be repeated. Once one side plank strengthening exercise is performed, the individual may reverse and perform the opposing modified side plank in substantially the same manner.

With reference now to FIG. 63, in one embodiment, level 3 may end with one final stretch. As shown in FIG. 63, the individual may spread their feet out. While their toes are rotated up toward the ceiling, the individual may place their left hand underneath their knee or calf on their left leg. The individual may lean over toward their left leg pulling their torso down while reaching the right hand up and over their head, as shown. The individual may feel the stretch along the obliques and into the quadratus lumborum. The instructor may direct the individual to rotate their chest forward and then hold the stretch for about five seconds. Once the stretch is performed, the individual may reverse the orientation of their hands and stretch out their left side in substantially the same manner as described above. In one embodiment, the individual may repeat the level 3 modalities two to three times a week with a rest day in between.

While the present invention has been illustrated by a description of various embodiments and while those embodiments have been described in considerable detail, it is not the intention of applicants to restrict or in any way limit the scope of the appended claims to such details. Additional advantages and modifications will readily appear to those skilled in the art. The invention in its broader aspects is therefore not limited to the specific details and illustrative examples shown and described. Accordingly, departures may be made from such details without departing from the spirit or scope of applicants' invention.

What is claimed is:

1. A kit for use in physical therapy by a person, comprising:
a first tension release device configured to apply pressure to at least one muscle of the person; and
a set of instructions associated with the kit and being in the form of written instructions and/or audio/visual instructions for the person to perform, the set of instructions comprising:
a first instruction to place pressure on at least one muscle of the person with the first tension release device,
a first instruction to stretch the at least one muscle of the person, and
a first instruction to strengthen at least one core muscle of the person.

2. The kit of claim 1, wherein the first instruction to place pressure on the at least one muscle is provided before the first instruction to stretch the at least one muscle.

3. The kit of claim 1, wherein the first instruction to place pressure on the at least one muscle is provided before the first instruction to strengthen the at least one core muscle.

4. The kit of claim 1, wherein the first instruction to place pressure on the at least one muscle is provided before the first instruction to stretch the at least one muscle, and the first instruction to stretch the at least one muscle is provided before the first instruction to strengthen the at least one core muscle.

5. The kit of claim 1, further comprising a strap for use with the first instruction to stretch the at least one muscle.

6. The kit of claim 1, wherein the first instruction to place pressure on the at least one muscle includes an instruction to place pressure on at least one golgi tendon organ of the at least one muscle.

7. The kit of claim 1, wherein the first instruction to place pressure on the at least one muscle includes an instruction to hold pressure in a stationary position on the at least one muscle for at least two seconds.

8. The kit of claim 1, wherein the at least one tension release device is at least one of a ball and/or a cylindrical roller.

9. The kit of claim 1, wherein the set of instructions is provided with the first tension release device.

10. The kit of claim 1, wherein the set of instructions is provided in downloadable form.

11. The kit of claim 1, further comprising:
a second tension release device different from the first tension release device, the second tension release device being configured to apply pressure to the at least one muscle of the person or another muscle of the person, and wherein the first instruction to place pressure on the at least one muscle of the person includes an instruction to place a second pressure on the at least one muscle or another muscle of the person with the second tension release device.

12. The kit of claim 11, wherein the second tension release device is configured to apply a pressure on the at least one muscle of the person that is greater than the pressure capable of being applied by the first tension release device.

13. The kit of claim 1, further comprising:
a second tension release device configured to apply a pressure that is greater than the pressure capable of being applied by the first tension release device; and
a second set of instructions associated with the kit and being in the form of written instructions and/or audio/visual instructions for the person to perform after the person performs the first set of instructions, the second set of instructions comprising:
a second instruction to place a second pressure on at least one second muscle of the person with the second tension release device,
a second instruction to stretch the at least one second muscle of the person, and
a second instruction to strengthen at least one core muscle of the person.

14. The kit of claim 13, wherein the at least one second muscle of the person is a different muscle than the at least one first muscle of the person.

15. The kit of claim 13, wherein the second instruction to place the second pressure on the at least one second muscle is provided before the second instruction to stretch the at least one second muscle of the person.

16. The kit of claim 13, wherein the second instruction to place pressure on the at least one second muscle is provided before the second instruction to stretch the at least one second muscle and the second instruction to stretch the at least one second muscle is before the second instruction to strengthen the at least one core muscle.

17. The kit of claim 13, further comprising:
a third tension release device configured to apply a pressure that is greater than the pressure capable of being applied by the second tension release device; and
a third set of instructions associated with the kit and being in the form of written instructions and/or audio/visual instructions for the person to perform after the person performs the second set of instructions, the third set of instructions comprising:
a third instruction to place a third pressure on at least one third muscle of the person with the third tension release device,
a third instruction to stretch the at least one third muscle of the person, and
a third instruction to strengthen at least one core muscle of the person.

18. A method of physical therapy for use by a person, comprising:
providing a first tension release device configured to apply pressure to at least one muscle of the person; and
providing a set of instructions to the person for the person to perform, the set of instructions comprising:
an instruction to place pressure on the at least one muscle of the person with the first tension release device,
an instruction to stretch the at least one muscle, and
an instruction to strengthen at least one core muscle.

19. The method of claim 18, wherein the set of instructions includes an instruction to place pressure on the at least one muscle by rolling the first tension release device on the at least one muscle.

20. The method of claim 18, wherein the instruction to place pressure on the at least one muscle of the person is before the instruction to stretch the at least one muscle.

21. The method of claim 18, wherein the instruction to place pressure on the at least one muscle of the first person is before the instruction to stretch the at least one muscle, and the instruction to stretch the at least one muscle is before the instruction to strengthen the at least one core muscle.

22. The method of claim 18, wherein the set of instructions includes an instruction to place pressure on at least one muscle in the person's back and/or in at least one of the person's legs.

23. The method of claim 18, further comprising:
providing a second tension release device configured to apply pressure to at least one second muscle of the person; and
providing a second set of instructions to the person for the person to perform after the person performs the first set of instructions, the second set of instructions comprise:
an instruction to place a second pressure on the at least one second muscle of the person with the second tension release device,
an instruction to stretch the at least one second muscle, and
an instruction to strengthen at least one core muscle.

24. The method of claim 23, wherein the instruction to place the second pressure on the at least one second muscle with the second tension release device is provided before the instruction to stretch the at least one second muscle, and the instruction to stretch the at least one second muscle is provided before the instruction to strengthen the at least one core muscle.

25. The method of claim 23 further comprising:
providing a third tension release device configured to apply pressure to at least one third muscle of the person; and
providing a third set of instructions to the person for the person to perform after the person performs the second set of instructions, the third set of instructions comprise:
an instruction to place a third pressure on the at least one third muscle of the person with the third tension release device,
an instruction to stretch the at least one third muscle, and
an instruction to strengthen at least one core muscle.

26. The method of claim 18, wherein providing the set of instructions to the person includes providing a QR code, a barcode, or a URL by which the set of instructions are accessible to the person.
